(19) United States
(12) Patent Application Publication
(10) Pub. No.: US 2018/0294892 A1
(43) Pub. Date: Oct. 11, 2018

(54) GENERATOR SET COMMUNICATION SYSTEM

(71) Applicant: Cummins Power Generation IP, Inc., Minneapolis, MN (US)

(72) Inventors: Khem Chapagain, Minneapolis, MN (US); Brian G. Haupt, Stillwater, MN (US); Kevin Keene, Coon Rapids, MN (US); Dennis McDonald, Minneapolis, MN (US)

(73) Assignee: Cummins Power Generation IP, Inc., Minneapolis, MN (US)

(21) Appl. No.: 15/481,810

(22) Filed: Apr. 7, 2017

(51) Int. Cl. H04B 10/80; H04B 10/077; H04B 10/50; H04B 10/2575; H04Q 11/00

(52) U.S. Cl. CPC H04B 10/808; H04B 10/077; H04B 10/5059; H04B 2203/5458; H04B 10/25753; H04Q 11/0066; H04B 10/5057

(57) ABSTRACT

Systems and apparatuses include a generator set including an electric generator, a sensor structured to provide a diagnostic signal, a controller, a light source, and a computer readable storage medium. The controller is configured to receive the diagnostic signal, determine an information code based on the diagnostic signal, and convert the information code to a flash sequence. The light source is configured to receive and output the flash sequence. The computer readable storage medium has instructions stored thereon that, upon execution by a processing circuit of a mobile device including an image capturing device and a display, cause the processing circuit to capture the flash sequence with the image capturing device, translate the flash sequence into information relating to the generator set, and provide the information on the display.

### TECHNICAL FIELD

The present disclosure relates to communication systems for generator sets. More particularly, the present disclosure relates to systems and methods for providing communications (e.g., diagnostic communications) between a user device and a generator set with a light source.

### BACKGROUND

Generator sets can include output devices that are designed to communicate fault diagnostics. However, the current methods of communicating diagnostic information are very limited in the type and amount of information that can be conveyed. Additionally, typically only basic diagnostic information can be conveyed through such methods, and more extensive information or non-diagnostic information cannot be conveyed to a user.

### SUMMARY

One embodiment relates to a system that includes a generator set including an electric generator, a sensor structured to provide a diagnostic signal, a controller, a light source, and a computer readable storage medium. The controller is configured to receive the diagnostic signal, determine an information code based on the diagnostic signal, and convert the information code to a flash sequence. The light source is configured to receive and output the flash sequence. The computer readable storage medium has instructions stored thereon that, upon execution by a processing circuit of a mobile device including an image capturing device and a display, cause the processing circuit to capture the flash sequence with the image capturing device, translate the flash sequence into information relating to the generator set, and provide the information on the display.

Another embodiment relates to a computer-readable storage medium having instructions stored thereon that, when executed by a processing circuit of a mobile device including a user interface, an image capturing device, and a display, cause the processing circuit to execute an operation that includes associating a generator set including a light source, identifying a database containing information related to the associated generator set, capturing a flash sequence produced by the light source with the image capturing device, querying the database for information related to the identified generator set based on the captured flash sequence, and displaying the information on the display.

Another embodiment relates to a method that includes associating, with a processing circuit, a generator set including a light source; identifying, with the processing circuit, a database containing information related to the associated generator set; capturing, with an image capturing device, a flash sequence produced by the light source; querying, with the processing circuit, the database for information related to the associated generator set based on the captured flash sequence; and displaying the information on a display of a mobile device.

Another embodiment relates to a generator set that includes an electric generator, a sensor associated with the electric generator and structured to provide a diagnostic signal, a controller including a processing circuit, and a light source. The controller is configured to receive the diagnostic signal, determine an information code based on the diagnostic signal, and translate the information code to a flash sequence communicating at a bandwidth of at least twenty bits per second. The light source is configured to receive and output the flash sequence.

These and other features, together with the organization and manner of operation thereof, will become apparent from the following detailed description when taken in conjunction with the accompanying drawings.

### BRIEF DESCRIPTION OF THE FIGURES

FIG. 1 is a schematic diagram of a generator set and a mobile device, according to an example embodiment.

FIG. 2 is a schematic diagram of a controller of the generator set of FIG. 1, according to an example embodiment.

FIG. 3 is a schematic diagram of a computer readable storage medium associated with the mobile device of FIG. 1, according to an example embodiment.

FIG. 4 is a flow diagram illustrating a method of communicating information from a generator set, according to an example embodiment.

### DETAILED DESCRIPTION

Following below are more detailed descriptions of various concepts related to, and implementations of, methods, apparatuses, and systems for communication between a user (e.g., a mobile device of a user) and a generator set. The various concepts introduced above and discussed in greater detail below may be implemented in any number of ways, as the concepts described are not limited to any particular manner of implementation. Examples of specific implementations and applications are provided primarily for illustrative purposes.

Referring to the figures generally, the various embodiments disclosed herein relate to systems, apparatuses, and methods for a computing device with a camera that can be aimed at a flashing diagnostic light of a generator set to automatically decode fault codes and/or other information. In various embodiments, the systems and methods of the present disclosure allow for conveyance of information from the generator set to the user without the user counting flashes and necessarily having knowledge to translate the sequence of flashes into information (e.g., awareness of location within a flash sequence to properly understand ordinality of digits, and the start of new fault codes). With the availability of automatic decoding, the information available through the flash sequence can be greatly expanded when compared to flash sequences that must be read by a human user. For example, flash sequences can communicate a significantly larger bandwidth or amount of information when the flash sequence is decoded automatically by a computer device. The increased amount of information cannot be decoded by a human user because the flash sequence contains more information than can be reliably detected by the human user.

Additional fault codes can be presented, and operational data can be made available that may be of great use to the user. For example, automatic decoding provides for the presentation of currently available generator set capacity, so that a user has knowledge about how much additional load can be added (for example, plugging in a curling iron in an RV). In addition, since the flash sequence no longer has to remain within the capability of a human to decode, the flash sequence can be altered and replaced with a more efficient and higher bandwidth modulation to encode and communicate a larger number of operational parameters to the computing device, turning it into a full-featured monitoring device. One convenient implementation of the computing device is a smart phone with a camera running a custom application. The user aims the smartphone camera at the generator set diagnostic light and can automatically decode diagnostic and runtime status and information (in an RV for example, a flashing diagnostic light is integrated into a start/stop button and located on the dash-board, or utility control panel). In other implementations, any other type of computing device could be utilized, such as a tablet, laptop, etc.

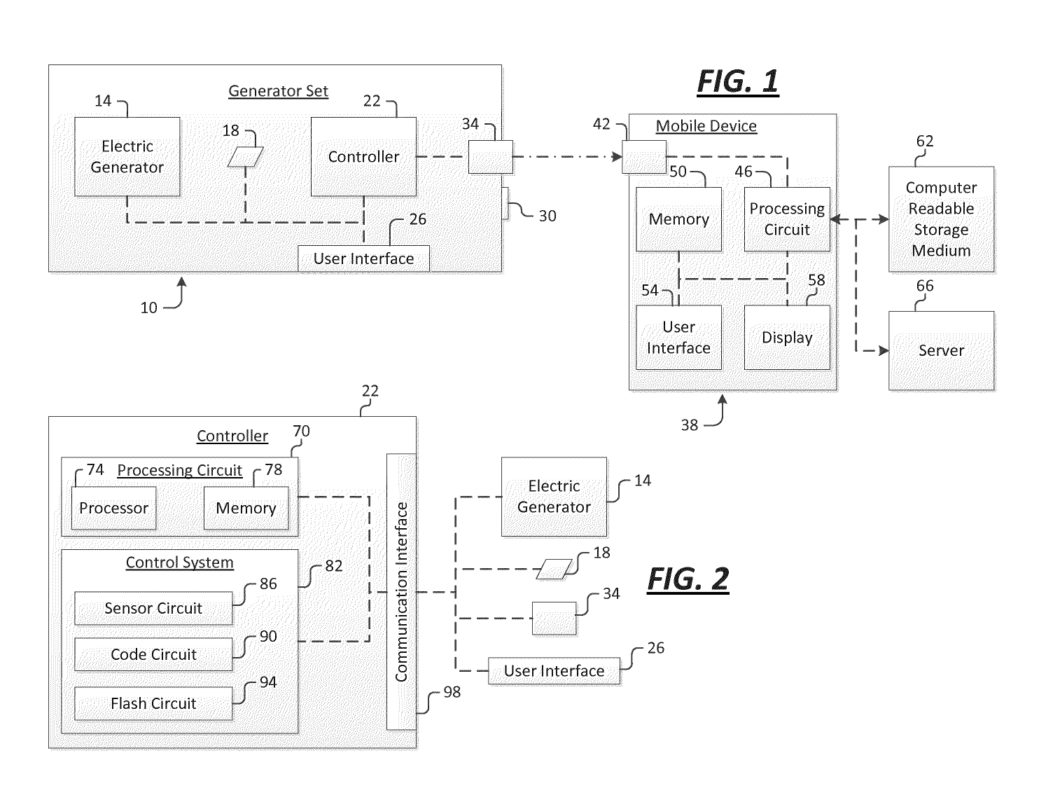

As shown in FIG. 1, a generator set 10 includes an electric generator 14, a sensor 18, a genset controller 22, a user interface 26, an identification tag 30, and a light source 34. In some embodiments, the electric generator 14 provides constant electrical power for use by a user. In some embodiments, the electric generator 14 is driven by an engine or other prime mover. In some embodiments, the electric generator 14 is a combined heat and power generator (cogeneration) or a combined heating, cooling, and power generator (trigeneration).

The sensor 18 is arranged in communication with the electric generator 14, the genset controller 22, and/or the user interface 26, and is positioned to measure a characteristic of the generator set 10 and output a diagnostic signal. In some embodiments, the characteristic includes a current draw, a power output, an output voltage, an active load, a global positioning system (GPS) coordinate, an operational state (e.g., on, off, idling), an engine related diagnostic (e.g., fuel level, fuel usage rate, emissions, knock detection, temperature, mass flow rate of fuel and/or air), or another characteristic as desired. The diagnostic signal is indicative of the sensed characteristic.

The genset controller 22 controls operation of the electric generator 14 and communicates with the electric generator 14, the sensor 18, the user interface 26, and the light source 34. The genset controller 22 receives the diagnostic signal from the sensor 18, and provides a flash sequence to the light source 34. More details of the genset controller 22 will be discussed below with respect to FIG. 2.

The user interface 26 can include a set of jumper switches, a serial interface, a wireless communication module, and/or a start button. The user interface 26 allows the user to affect operation of the generator set 10 and communicates user input to the genset controller 22. In some embodiments, the user interface 26 can include other features such as a keypad, a directional pad, a display screen, etc.

The identification tag 30 can include a QR code, a barcode, a serial number, a model number, a fleet number, or another feature that identifies the generator set. In some embodiments, the identification tag is a sticker adhered to an exterior of the generator set 10. In some embodiments, the identification tag may be an RFID tag or another tag that identifies the generator set 10. The identification tag 30 is one example of an identifier that is used to associate or recognize the generator set 10.

The light source 34 includes an LED that is visible on the exterior of the generator set 10. In some embodiments, the light source 34 provides visible light according to the flash sequence provided by the genset controller 22. In some embodiments, the light source provides UV or IR light according to the flash sequence provided by the genset controller 22. In some embodiments, the light source 34 includes multiple LEDs. In some embodiments, the light source 34 can provide a combination of UV, visible, and IR light. In some embodiments, the light source 34 includes an incandescent bulb, a fluorescent bulb, a halogen bulb, or another type of light producing element.

With continued reference to FIG. 1, a mobile device 38 includes an image capture device 42, and a mobile device processing circuit 46 in communication with the image capture device 42, a memory 50, a user interface 54, and a display 58. The image capturing device 42 is capable of recording images and/or video. The mobile device processing circuit 46 operates the mobile device 38 in response to input from the user interface 54, and may execute operations in response to instructions stored on the memory 50. The user interface 54 may include a touch screen, a keypad, or another interface, as desired. In some embodiments, the mobile device 38 is a mobile phone or a smart phone. In some embodiments, the mobile device 38 includes a tablet, a computer, a laptop, a watch with image capture capability, a wearable device, a personal digital assistant (PDA), a dedicated diagnostic device, or another mobile device with image capturing capabilities.

A computer readable storage medium 62 is associated with the mobile device 38 and may take the form of an internal memory housed within the mobile device 38, a remote memory housed outside of the mobile device 38, or a remote server. The computer readable storage medium 62 includes instructions stored thereon that can be executed by the mobile device processing circuit 46. In some embodiments, the computer readable storage medium 62 is arranged to communicate with the memory 50 such that the instructions can be downloaded, transferred, or otherwise stored on the memory 50 housed within the mobile device 38. Once the instructions are transferred from the computer readable storage medium 62 to the memory 50, the instructions may be executed by the mobile device processing circuit 46 without requiring communication with the computer readable storage medium 62.

A server 66 is arranged in communication with the mobile device 38 and may store additional information, provide additional information to the mobile device 38, and/or be used to coordinate operation with other mobile devices. In some embodiments, the server 66 is associated with a mobile cellular or data network. For example, in some embodiments, the server 66 and the mobile device 38 communicate via a wireless network, which may include one or more of a variety of networking technologies (e.g., LAN, WAN, WiFi, cellular, such as CDMA or GSM, etc.).

As shown in FIG. 2, the genset controller 22 may be separate from or included with the electric generator 14. The genset controller 22 includes a genset processing circuit 70 having a processor 74 and a memory device 78; a control system 82 having a sensor circuit 86 structured to receive the diagnostic signal from the sensor 18, a code circuit 90 structured to determine an information code based at least in part on the received diagnostic signal, and a flash circuit 94 structured to convert the information code to a flash sequence; and a communications interface 98. Generally, the genset controller 22 is structured to receive the diagnostic signal from the sensor 18, determine the information code based on the diagnostic signal, and convert the information code to a flash sequence. The flash sequence can then be sent from the communications interface 98 to the light source 34. In some embodiments, the diagnostic signal is indicative of faults or other operational conditions of the genset, but it should be understood that the diagnostic signal can additionally or alternatively include information other than faults/operational conditions, and any information pertinent to the genset should be considered to fall within the scope of the diagnostic signals/data/information described herein unless otherwise indicated.

In one configuration, the sensor circuit 86, the code circuit 90, and the flash circuit 94 are embodied as machine or computer-readable media having instructions stored thereon that are executable by a processor, such as processor 74. As described herein and amongst other uses, the instructions facilitate performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the sensor circuit 86, the code circuit 90, and the flash circuit 94 are embodied as hardware units, such as electronic control units. As such, the sensor circuit 86, the code circuit 90, and the flash circuit 94 may be embodied as one or more circuitry components including, but not limited to, processing circuitry, network interfaces, peripheral devices, input devices, output devices, sensors, etc. In some embodiments, the sensor circuit 86, the code circuit 90, and the flash circuit 94 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the sensor circuit 86, the code circuit 90, and the flash circuit 94 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The sensor circuit 86, the code circuit 90, and the flash circuit 94 may also include programmable hardware devices such as field programmable gate arrays, programmable array logic, programmable logic devices or the like. The sensor circuit 86, the code circuit 90, and the flash circuit 94 may include one or more memory devices for storing instructions that are executable by the processor(s) of the sensor circuit 86, the code circuit 90, and the flash circuit 94. The one or more memory devices and processor(s) may have the same definition as provided below with respect to the memory device 78 and processor 74. In some hardware unit configurations, the sensor circuit 86, the code circuit 90, and the flash circuit 94 may be geographically dispersed throughout separate locations in the vehicle. Alternatively and as shown, the sensor circuit 86, the code circuit 90, and the flash circuit 94 may be embodied in or within a single unit/housing, which is shown as the genset controller 22.

In the example shown, the genset controller 22 includes a genset processing circuit 70 having a processor 74 and a memory device 78. The genset processing circuit 70 may be structured or configured to execute or implement the instructions, commands, and/or control processes described herein with respect to the sensor circuit 86, the code circuit 90, and the flash circuit 94. The depicted configuration represents the sensor circuit 86, the code circuit 90, and the flash circuit 94 as machine or computer-readable media. However, as mentioned above, this illustration is not meant to be limiting as the present disclosure contemplates other embodiments where the sensor circuit 86, the code circuit 90, and the flash circuit 94, or at least one circuit of the sensor circuit 86, the code circuit 90, and the flash circuit 94, is configured as a hardware unit. All such combinations and variations are intended to fall within the scope of the present disclosure.

The processor 74 may be implemented as one or more general-purpose processor, an application specific integrated circuit (ASIC), one or more field programmable gate arrays (FPGAs), a digital signal processor (DSP), a group of processing components, or other suitable electronic processing components. In some embodiments, the one or more processors may be shared by multiple circuits (e.g., the sensor circuit 86, the code circuit 90, and the flash circuit 94 may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure. The memory device 78 (e.g., RAM, ROM, Flash Memory, hard disk storage, etc.) may store data and/or computer code for facilitating the various processes described herein. The memory device 78 may be communicably connected to the processor 74 to provide computer code or instructions to the processor 74 for executing at least some of the processes described herein. Moreover, the memory device 78 may be or include tangible, non-transient volatile memory or non-volatile memory. Accordingly, the memory device 78 may include database components, object code components, script components, or any other type of information structure for supporting the various activities and information structures described herein.

The sensor circuit 86 is structured to receive the diagnostic signal from the sensor 18 and to determine a system characteristic based on the received diagnostic signal. The system characteristic may be related to operational parameters or conditions of the generator set 10, or may include usage information. In some embodiments, the sensor circuit 86 is in communication with more than one sensor and receives a number of diagnostic signals and determines a number of system characteristics. In some embodiments, a number of diagnostic signals may be used to determine a single system characteristic.

The code circuit 90 is structured to receive the system characteristic from the sensor circuit 86 and determine an information code based on the system characteristic. The information code may include a number of system characteristics. In some embodiments, the information code may include at least one of a fault code, a current usage, an active load, a remaining load capacity, global positioning system coordinates, a maintenance record, and a usage history. In some embodiments, the user interface 26 of the generator set 10 is used to select the particular system characteristics that are included in the information code. For example, each available system characteristic may be associated with a jump switch of the user interface 26 and a user may select which system characteristics are included in the information code by interacting with the jump switches. In some embodiments, the user interface 26 includes a serial interface, a wireless communication module, or a start button interface that the user may interact with to select the system characteristics that are included in the information code. In some embodiments, where the user interface 26 is a start button, the user may select system characteristics related to run time information by pushing the start button once, system characteristics related to maintenance codes by pushing the start button twice, and system characteristics related to a full diagnostic by pushing the start button three times.

The flash circuit 94 is structured to receive the information code from the code circuit 94 and to develop a flash sequence that encodes the information code. The flash sequence is provided to the light source 34 such that the flash sequence is reproduced by the light source and available to be received by the image capture device 42 of the mobile device 38. In some embodiments, the flash sequence communicates at a bandwidth of at least about forty-four bits per second (44 b/S). In some embodiments, the flash sequence communicates at a bandwidth between about twenty bits per second (20 b/S) and about sixty bits per second (60 b/S). In some embodiments, the flash sequence communicates at a frequency between about thirty Hertz (30 Hz) and about seventy Hertz (70 Hz). In some embodiments, the flash sequence characteristics (e.g., flash frequency/speed) may be adjusted based on the mobile device 38 (e.g., may be adjusted based on capabilities of the image capture device 42, such as a capture speed capability). In some exemplary embodiments, the mobile device 38 defines a capture rate of about two-hundred-forty frames per second (240 f/S) corresponding to a frame sample rate of about four microseconds (4 mS). The flash sequence may communicate at about fifty Hertz (50 Hz) at intervals of about ten microseconds (10 mS) on and ten microseconds (10 mS) off. In some embodiments, the exemplary flash sequence is not interpretable by the human eye (i.e., flashes at a faster rate than can be interpreted by the human eye and brain). In some implementations, the flash sequence communicates about forty-four bits per second (44 b/S). In one example, about seven bits (7 b) of information is communicated in about one-hundred-sixty microseconds (160 mS). Additionally, the information coding can be changed from on/off pulses to a binary information stream because the flash sequence does not have to be decoded by a human. The flash sequence utilizes a type of binary communication that is more efficient than an on/off flash sequence that is interpretable by the human eye, in some implementations. As a result, the flash frequency to bit-rate comparison is not proportional (e.g., the flashing sequence may be about 30 times faster and transfer about 80 times more information).

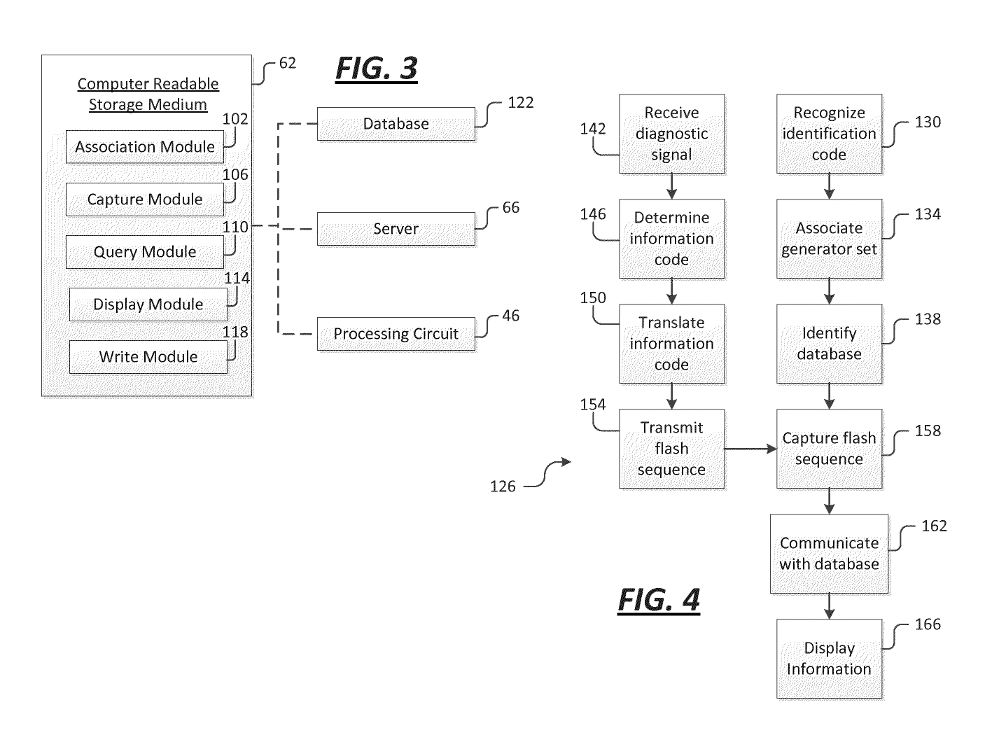

As shown in FIG. 3, the computer readable storage medium 62 includes an instruction set in the form of an association module 102, a capture module 106, a query module 110, a display module 114, and a write module 118. As discussed above, the instruction set is transferable and may be executed by the mobile device processing circuit 46 directly from the computer readable storage medium 62, or from another location. For example, the instruction set may be transferred to the memory 50 of the mobile device 38 or to the memory 78 of the genset controller 22, and the mobile device processing circuit 46 is structured to execute an operation according to the instruction set.

The association module 102 is structured to instruct the mobile device processing circuit 46 to retrieve association information regarding the generator set 10. In some embodiments, the association module 102 instructs the mobile device processing circuit 46 to identify the identification tag 30 using the image capture device 42. For example, the identification tag 30 can include a quick response (QR) code that is recognized by the image capture device 42, and the mobile device processing circuit 46 is structured to read the QR code to identify or associate the generator set 10. In some embodiments, the association module 102 receives a different identifier in the form of a manually entered code or text string. Associating the generator set 10 includes identifying a database 122 arranged in communication with the computer readable storage medium 62, the mobile device processing circuit 46, or the genset controller 22. In some embodiments, the database 122 is structured as a part of the memory 50. In some embodiments, the database 122 is structured as a part of the server 66. In some embodiments, the database 122 is a standalone device or memory. The generator set information can be accessed from the database 122 and can include the model information of the generator set 10, a list of information codes corresponding to the generator set 10, or other information related to the generator set 10. In some embodiments, the generator set information can include cloud based information related to a sub set or fleet of generator sets of which the generator set 10 is a part. In some embodiments, the generator set information may include fleet operational or maintenance trends or records, or other information related to a fleet or group of generator sets.

The capture module 106 is structured to instruct the mobile device processing circuit 46 to access the image capture device 42 and capture a video of the flash sequence reproduced by the light source 34. The capture module 106 is also structured to instruct the mobile device processing circuit 46 to save the captured video of the flash sequence to the memory 50.

The query module 110 is structured to instruct the mobile device processing circuit 46 to identify the flash sequence from the captured video. The mobile device processing circuit 46 is then instructed to query the server 66 for the information code corresponding to the flash sequence. In some embodiments, the mobile device processing circuit 46 is instructed to query the server 66 for descriptive information corresponding to the flash sequence that may explain the information code in longer format or a richer information format. For example, while the information code may be an alphanumeric string or a binary code, the descriptive information can include paragraphs or sentences describing the determined characteristics of the generator set 10. In other words, the query module 110 is structured to instruct the mobile device processing circuit 46 to translate the flash sequence into information relating to the generator set 10. In some embodiments, the translation includes communication with the server 66. In some embodiments, the translation includes communication with the memory 50.

The display module 114 is structured to instruct the mobile device processing circuit 46 to provide the information to the display 58 of the mobile device 38 so that the user can read the information and digest the desired system characteristics of the generator set 10. As discussed above, the information can include detailed information that is easily understood by the average user. In some embodiments, the information may include an indication of required maintenance, specific maintenance tasks that are required, a fault code, a current usage, an active load, a remaining load capacity, global positioning system coordinates, a maintenance record, and/or a usage history. These and other system characteristics can be displayed and may include charts, graphs, infographics, links to external websites, or other features that aid a user in understanding or responding to the information.

The write module 118 is structured to instruct the mobile device processing circuit 46 to upload or write the information code translated by the query module 110 to the server 66. Writing the information code to the server 66 allows for fleet coordination and general statistic keeping. For example, usage and maintenance statistics and/or information can be kept about a particular model of generator sets such that maintenance needs can be more accurately prescribed.

The modules 102, 106, 110, 114, and 118 are discussed above with respect to specific instructions. However, instructions may be combined within different modules, various modules or instructions may be combined or separated, or otherwise altered while still providing instructions to capture the flash sequence, translate the flash sequence into information, and display the information to the user.

As shown in FIG. 4, a method 126 of communicating information from the generator set 10 to the display of the mobile device 38 includes recognizing, at step 130, an identifier or identification code of the generator set 10 with the mobile device 38. In some embodiments, recognizing the information code includes the association module 102 instructing the mobile device processing circuit 46 to capture an image of the identification tag 30 using the image capture device 42. In some embodiments, recognizing the information code includes the association module 102 instructing the mobile device processing circuit 46 to prompt the user via the display 58 to enter the identification code (e.g., serial number, model number, proprietary ID, etc.) via the user interface 54.

At step 134, the association module 102 instructs the mobile device processing circuit 46 to identify the generator set 10 using the captured image or the entered code. At step 138, the association module 102 instructs the mobile device processing circuit 46 to identify the database 122 and associate the recognized generator set 10 within the database 122. In some embodiments, associating the generator set 10 within the database 122 includes linking the generator set 10 to a group of generator sets or a fleet of generator sets.

At step 142, the sensor circuit 86 of the genset controller 22 receives the diagnostic signal from the sensor 18. The sensor circuit 86 then determines the system characteristic based on the received diagnostic signal. At step 146, the code circuit 90 of the genset controller 22 receives the system characteristic from the sensor circuit 86 and determines the information code. In some embodiments, the information code includes a number of different system characteristics. At step 150, the flash circuit 94 of the genset controller 22 receives the information code from the code circuit 90. The flash circuit 94 then translates the information code into a flash sequence. At step 154, the flash sequence is reproduced by the light source 34. In some embodiments, the flash sequence is reproduced by a flashing LED of the light source 34.

At step 158, the capture module 106 instructs the mobile device processing circuit 46 to capture the flash sequence using the image capture device 42. At step 162, the query module 110 instructs the mobile device processing circuit 46 to communicate with the database 122, the server 66, and/or the memory 50 in order to retrieve information corresponding to the flash sequence. Additionally, information may be written to the database 122, the server 66, and/or the memory 50 at step 162. The information received and/or written may include at least one of a fault code, a current usage, an active load, a remaining load capacity, global positioning system coordinates, a maintenance record, and a usage history. Additionally, the information received and/or written may include fleet or group information that aids in the coordination of a group or fleet of generator sets. In some embodiments, the processing of the flash sequence (e.g., identifying or translating the flash sequence into the information) is executed on the mobile device processing circuit 46. In some embodiments, the processing of the flash sequence is executed remotely on the server 66 and the information is sent back to the mobile device processing circuit 46.

At step 166, the information retrieved from the database 122, the server 66, and/or the memory 50 is displayed on the display 58 of the mobile device 38 so that the user can read and understand the information.

The method 126 allows the user to retrieve a set of diagnostic information from the generator set 10 with a mobile device 38 without the need for complicated and expensive genset controllers and interfaces. The mobile device 38 can be a smartphone that the user already owns allowing for a rich, interactive user interface for the generator set 10 without adding complexity and cost to the generator set 10.

In some embodiments, the systems and methods discussed above can use GPS data of the mobile device 38 at the time of connection or communication with the generator set 10 to track a location of the generator set 10. This may provide advantageous locating capabilities in case of theft or physical loss. In some embodiments, the flash sequence uses Hamming codes or CRC.

No claim element herein is to be construed under the provisions of 35 U.S.C. § 112(f), unless the element is expressly recited using the phrase “means for.”

For the purpose of this disclosure, the term “coupled” means the joining or linking of two members directly or indirectly to one another. Such joining may be stationary or moveable in nature. For example, a propeller shaft of an engine “coupled” to a transmission represents a moveable coupling. Such joining may be achieved with the two members or the two members and any additional intermediate members. For example, circuit A communicably “coupled” to circuit B may signify that the circuit A communicates directly with circuit B (i.e., no intermediary) or communicates indirectly with circuit B (e.g., through one or more intermediaries).

While various circuits with particular functionality are shown in FIGS. 1-3, it should be understood that the genset controller 22 and the mobile device 38 may include any number of circuits for completing the functions described herein. For example, the activities and functionalities of the circuits 70, 86, 90, 94 may be combined in multiple circuits or as a single circuit. Additional circuits with additional functionality may also be included. Further, the genset controller 22 may further control other activity beyond the scope of the present disclosure.

As mentioned above and in one configuration, the “circuits” may be implemented in machine-readable medium for execution by various types of processors, such as processor 74 of FIG. 2. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Although the diagrams herein may show a specific order and composition of method steps, the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. All such modifications are intended to be included within the scope of the present disclosure as defined in the appended claims. Such variations will depend on the machine-readable media and hardware systems chosen and on designer choice. All such variations are within the scope of the disclosure.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

Accordingly, the present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

1. A system comprising:
a generator set comprising:
an electric generator;
a sensor structured to provide a diagnostic signal;
a controller configured to
receive the diagnostic signal,
determine an information code based on the diagnostic signal, and
convert the information code to a flash sequence; and
a light source configured to receive and output the flash sequence; and
a computer readable storage medium having instructions stored thereon that, upon execution by a processing circuit of a mobile device including an image capturing device and a display, cause the processing circuit to:
capture the flash sequence with the image capturing device, translate the flash sequence into information relating to the generator set, and
provide the information on the display,
wherein the instructions cause the processing circuit of the mobile device to communicate the information to a server configured to monitor information relating to a group of generator sets.

2. The system of claim 1, wherein the information code includes at least one of a fault code, a current usage, an active load, a remaining load capacity, global positioning system coordinates, a maintenance record, and a usage history.

3. The system of claim 1, wherein data included in the information code is selectable via at least one of jump switches, a serial interface, a wireless communication module of the generator set, or a start button interface of the generator set.

4. (canceled)

5. The system of claim 1, wherein translating the flash sequence into the information comprises:
transmitting the flash sequence to the server, and
receiving the information correlated to the flash sequence from the server.

6. The system of claim 1, wherein translating the flash sequence into the information comprises:
comparing the flash sequence to data stored in a memory of the mobile device, and
retrieving the information correlated to the flash sequence from the memory.

7. The system of claim 1, wherein the generator set is configured to communicate the flash sequence to the mobile device at a bandwidth of at least twenty bits per second.

8. The system of claim 1, wherein the generator set is configured to illuminate the light source at a frequency between about thirty Hertz and about seventy Hertz to communicate the flash sequence to the mobile device.

9. The system of claim 1, wherein the instructions further cause the processing circuit to recognize the generator set based on a generator set information received from one of the image capturing device and a user interface of the mobile device.

10. A non-transitory computer-readable storage medium having instructions stored thereon that, when executed by a processing circuit of a mobile device including a user interface, an image capturing device, and a display, cause the processing circuit to execute an operation comprising:
recognizing an identifier of a generator set including a light source;
identifying a database associated with the identifier, the database containing information related to the generator set;
capturing a flash sequence produced by the light source with the image capturing device;
querying the database for information related to the identified generator set based on the captured flash sequence;
displaying the information on the display; and
communicating the information, via the mobile device, to a server associated with a group of generator sets and configured to monitor the group of generator sets.

11. The non-transitory computer-readable storage medium of claim 10, wherein the identifier is received from one of the user interface or the image capturing device.

12. The non-transitory computer-readable storage medium of claim 11, wherein the identifier includes at least one a generator set identification code, and a QR sticker on the generator set.

13. The non-transitory computer-readable storage medium of claim 10, wherein the information includes at least one of a fault code, a current usage, an active load, a remaining load capacity, global positioning system coordinates, a maintenance record, and a usage history.

14. (canceled)

15. The non-transitory computer-readable storage medium of claim 10, wherein the flash sequence communicates information at least twenty bits per second.

16. A method comprising:
recognizing, with a processing circuit of a mobile device, an identifier of a generator set including a light source;
identifying, with the processing circuit, a database containing information related to the generator set;
capturing, with an image capturing device, a flash sequence produced by the light source;
querying, with the processing circuit, the database for information related to the generator set based on the captured flash sequence;
displaying the information on a display of the mobile device; and
communicating the information, via the mobile device, to a server associated with a group of generator sets and configured to monitor the group of generator sets.

17. The method of claim 16, further comprising:
receiving, with a controller, a diagnostic signal from a sensor configured to monitor a characteristic of the generator set;
determining, with the controller, an information code based on the diagnostic signal; and
translating, with the controller, the information code to the flash sequence.

18. The method of claim 17, wherein recognizing the identifier includes receiving a generator set identification code from one of a user interface or an image capturing device of the mobile device.

19. The method of claim 16, wherein the information includes at least one of a fault code, a current usage, an active load, a remaining load capacity, global positioning system coordinates, a maintenance record, and a usage history.

20. The method of claim 16, wherein the flash sequence communicates information at least twenty bits per second.

21-25. (canceled)

26. A system for monitoring a plurality of generator sets, the system comprising:
a memory having instructions stored thereon; and
a processor configured to execute the instructions to:
receive information from a plurality of mobile devices, the information generated in response to flash sequences of a light source of a generator set, the flash sequences captured by the plurality of mobile devices, and
remotely monitor the plurality of generator sets using the information received from the plurality of mobile devices.

27. The system of claim 26, wherein the processor is further configured to use the information to determine usage and maintenance statistics corresponding to the plurality of generator sets.

28. The system of claim 26, wherein the processor is configured to monitor coordination between the plurality of generator sets.

29. The system of claim 26, wherein the processor is configured to store the information, the information including model information for the generator set.

30. The system of claim 29, wherein the processor is configured to group and analyze the information based on the model information for each of the plurality of generator sets.
